(19) United States
(12) Patent Application Publication
(10) Pub. No.: US 2018/0299750 A1
(43) Pub. Date: Oct. 18, 2018

(54) CAMERA SUPPORT SYSTEM

(71) Applicant: PARROT DRONES, Paris (FR)

(72) Inventors: Jean-François VUILLET, VANVES (FR); Christine CAUBEL, PARIS (FR); Guillaume CHEVRIER, THIL (FR)

(21) Appl. No.: 15/487,489

(22) Filed: Apr. 14, 2017

(51) Int. Cl. G03B 17/56; F16M 13/02; F16M 11/12; F16M 11/18; F16M 13/04; B64D 47/08; F16B 21/12

(52) U.S. Cl. CPC G03B 17/561; F16M 13/022; F16M 11/12; F16M 11/18; F16M 2200/08; B64D 47/08; F16B 21/12; G03B 17/566; F16M 13/04

(57) ABSTRACT

A camera support system includes a base configured to be fixedly attached to an object, the base including a base coupling part; a support assembly configured for releasable coupling with the base, the support assembly including a support assembly coupling part configured for engaging with the base coupling part along a coupling axis and a camera supporting part for supporting a camera with allowing spatial orientation of the camera about at least one rotation axis; and a locking ring pivotally mounted on the support assembly about the coupling axis for locking the support assembly with the base, the support assembly being configured for releasably coupling to the base by engaging the support assembly coupling part with the base coupling part along the coupling axis and subsequently pivoting the locking ring about the coupling axis for locking the support assembly to the base.

The present invention relates to a camera support system for mounting a camera to an object such as vehicle or a handheld support, in particular to an aerial vehicle such as a drone.

### BACKGROUND

U.S. Pat. No. 9,280,038B1 discloses a payload mounting system adapted for mounting a payload such as a camera onto an aerial vehicle or a handheld support. The payload mounting system comprises a base to be fixedly attached to the aerial vehicle or the handheld support, a payload support assembly for carrying the camera with controlling spatial orientation of the camera and a quick coupling mechanism for releasably coupling the support assembly to the base.

### SUMMARY OF THE INVENTION

Manually coupling the support assembly to the base may sometimes prove difficult as the user has to manipulate the base, the payload support assembly and the coupling mechanism all at the same time.

An object of the invention is to provide a camera support system that allows mounting the camera to an object with ease.

To this end, a camera support system is provided. The camera support system includes a base configured to be fixedly attached to an object, the base including a base coupling part; a support assembly configured for releasable coupling with the base, the support assembly including a support assembly coupling part configured for engaging with the base coupling part along a coupling axis and a camera supporting part for supporting a camera with allowing spatial orientation of the camera about at least one rotation axis; and a locking ring pivotally mounted on the support assembly about the coupling axis for locking the support assembly with the base, the support assembly being configured for releasably coupling to the base by engaging the support assembly coupling part with the base coupling part along the coupling axis and subsequently pivoting the locking ring about the coupling axis for locking the support assembly to the base.

Providing the locking ring on the support assembly allows easy coupling and locking of the support assembly with the base with one single hand, namely with holding the support assembly via the locking ring for engaging the support assembly with the base, and pivoting the locking ring with said same hand for locking the locking system.

The camera support system may also include one or more of the following features:

the locking ring is provided with locking pins each configured for insertion into a corresponding groove of the base coupling part and for abutting a corresponding locking surface after rotation of the locking ring;

at least one of the locking surfaces is provided with a step configured to cooperate with the locking pin to prevent unintentional unlocking of the locking ring;

the support assembly coupling part comprises at least one indexing pin, each indexing pin configured to be aligned with a respective locking pin for engaging the support assembly coupling part with the base coupling part;

each indexing pin is configured for preventing rotation of the support assembly coupling part with respect to the base coupling part about the coupling axis once the support assembly coupling part is engaged with respect to the base coupling part;

the support assembly is configured for allowing rotation of the camera with respect to the base about at least two rotation axes distinct from each other;

the at least two rotation axes are perpendicular to each other;

the support assembly is configured for allowing rotation of the camera about three rotation axes, each rotation axis being perpendicular with each of the two other rotation axes;

the base comprises a base electric connector and the support assembly comprises a support assembly electric connector configured for connecting upon coupling the support assembly coupling part to the base coupling part;

at least one spacer for maintaining a predetermined minimal spacing between the electrical connectors when the support assembly coupling part is coupled to the base coupling part;

the at least one spacer is provided as at least one spacer pin disposed on the base coupling part and configured for contacting a piece of the support assembly coupling part supporting the support assembly electrical connector;

said at least one spacer pin contacts the board through at least one corresponding aperture of a cover of the support assembly coupling part, said cover covering the piece supporting the support assembly electrical connector;

each spacer pin and the corresponding aperture cooperate to prevent rotation of the support assembly coupling part with respect to the base coupling part about the coupling axis once the support assembly coupling part is engaged with respect to the base coupling part;

at least one compressible elastic member interposed between a support piece of the support assembly coupling part and the support assembly connector, the elastic member being compressed upon coupling the support assembly coupling part with the base coupling part;

the locking ring is axially movable along the coupling axis with respect to the support assembly coupling part, the camera support system comprising at least one elastic member configured for urging the locking ring and the support assembly coupling part away from each other;

a compressible elastic member arranged to be compressed between the support assembly coupling part and the base coupling part upon engaging the support assembly coupling part with the base coupling part;

the camera supporting part is mounted on the support assembly coupling part;

the camera supporting part comprises a first supporting member part which is pivotally mounted on the support assembly coupling part about a first rotation axis;

the first axis of rotation coincides with the coupling axis;

the camera supporting part comprises a second supporting member hinged to the first supporting member part about a second rotation axis;

the camera supporting part comprises a third supporting member hinged to the second supporting member part about a third rotation axis;

at least one motor for actively controlling orientation of the camera; and

the object is a vehicle or a handheld support.

### BRIEF SUMMARY OF THE DRAWINGS

The invention and its advantages will be better understood on reading the following description given solely by way of non-limiting example and with reference to the appended drawings, in which:

FIG. 1 is a perspective view of the camera support system comprising a base and a camera support assembly;

FIG. 2 is a perspective view of the base;

FIG. 3 is a perspective view of the camera support assembly comprising a locking ring;

FIG. 4 is a perspective sectional view of the base;

FIG. 5 is a partial perspective exploded view of the support assembly illustrating a coupling part of the support assembly and the locking ring;

FIG. 6 is a sectional view of the locking ring illustrating a holding system;

FIGS. 7 and 8 are perspective views illustrating a clamping system;

FIG. 9 is a diagrammatic view illustrating another clamping system;

FIG. 10 is a diagrammatic view illustrating another holding system;

FIG. 11 is a partial perspective exploded view illustrating another clamping system;

FIG. 12 is a partial perspective exploded view illustrating a locking ring and an associated sliding ring according of a support assembly coupling part according to one embodiment; and

FIG. 13 is a cross-sectional view of a portion of the camera support system including a yaw motor.

### DETAILED DESCRIPTION

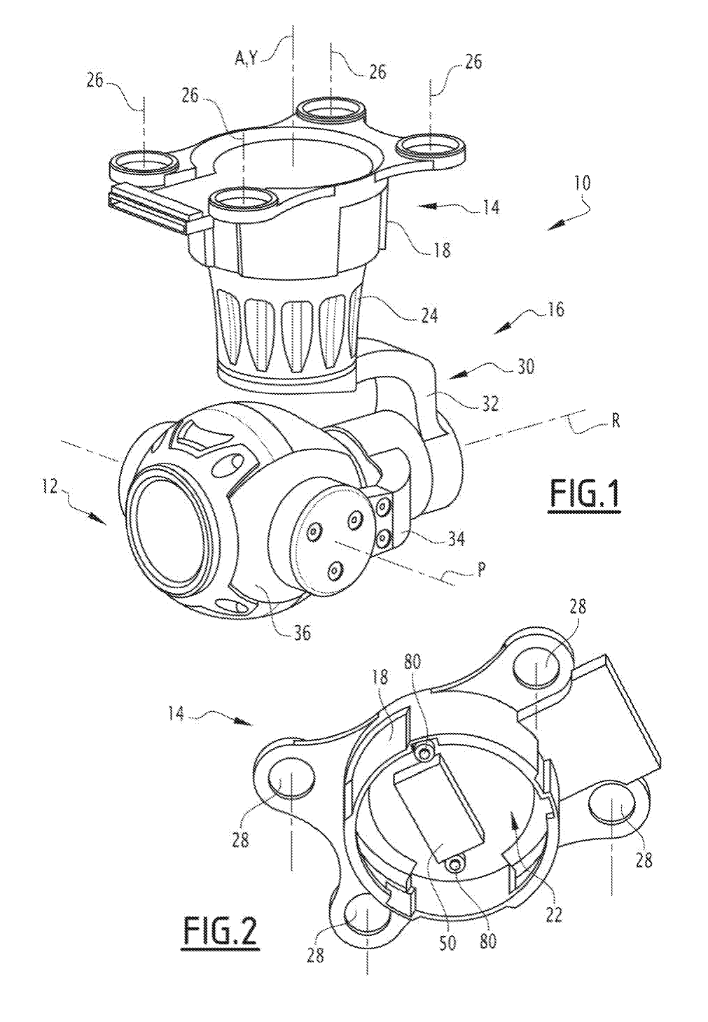

The camera support system 10 illustrated on FIGS. 1-3 is configured for releasable mounting of a camera 12 onto an object such as a vehicle or a handheld support. The vehicle may be an aerial vehicle, in particular a drone.

The camera support system 10 comprises a base 14 configured to be fixedly attached to the object and a support assembly 16 configured for carrying the camera 12, the base 14 and the support assembly 16 being configured for releasable coupling of the support assembly 16 to the base 14.

The base 14 and the support assembly 16 comprise respectively a base coupling part 18 and a support assembly coupling part 20 which are configured for engaging one into the other axially along a coupling axis A.

As illustrated, the base coupling part 18 is a female part and the support assembly coupling part 20 is male part. The base coupling part 18 defines a cavity 22 for receiving the support assembly coupling part 20.

The camera support system 10 comprises a locking ring 24 which is mounted on the support assembly 16 pivotally about the coupling axis A, the locking ring 24 being configured for locking or unlocking the support assembly coupling part 20 to the base coupling part 18 by manually rotating the locking ring 24 about the coupling axis A when the support assembly coupling part 20 to the base coupling part 18 are engaged one into the other.

Typically, the locking ring 24 is pivoted substantially 60° about the coupling axis A for locking or unlocking. Such a locking ring 24 forms a so called “bayonet mount”.

The base 14 is configured to be fixedly connected to an object, for example using screws 26 illustrated schematically in FIG. 1 in dash-dotted lines. The base 14 comprises screw openings 28 for screwing the base 14 to the object.

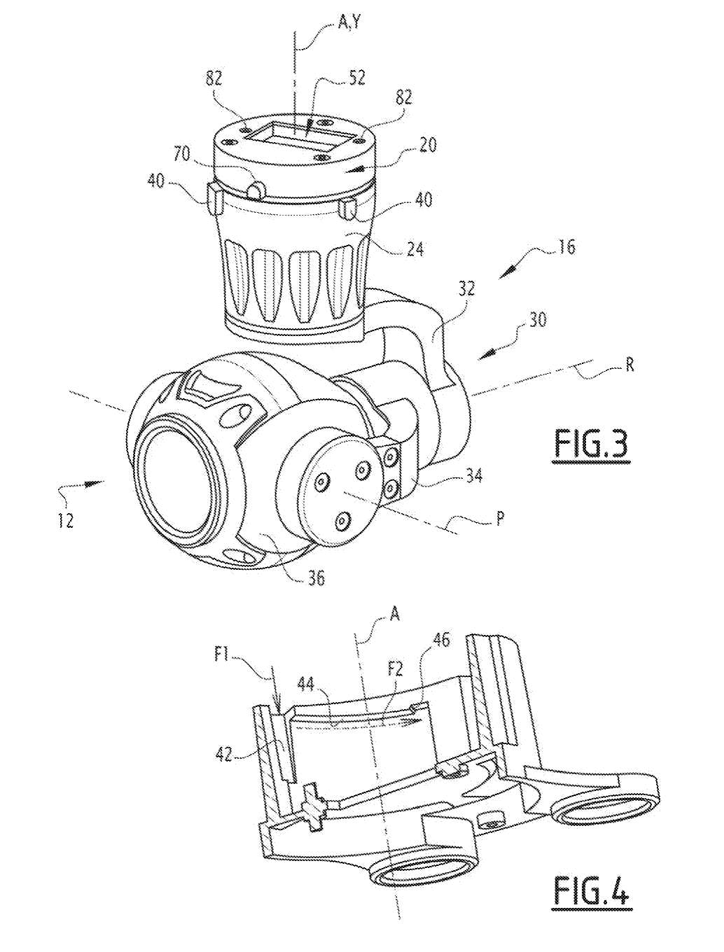

As illustrated on FIG. 3, the support assembly 16 comprises a camera supporting part 30 which is mounted on the support assembly coupling part 20 and which is configured for carrying the camera 12 with allowing spatial orientation of the camera about at least one rotation axis with respect to the support assembly coupling part 20, and hence with respect to a object on which the support assembly 16 is coupled via the base 14.

In the example, the camera supporting part 30 allows spatial orientation of the camera about three rotation axes which are distinct from each other. Each of the three rotation axes is perpendicular to each of the two other rotation axes. The camera supporting part here allows rotation of the camera about a yaw axis Y, a roll axis R and a pitch axis P.

In the example, the yaw axis Y coincides with the coupling axis A.

The camera supporting part 30 comprises supporting members which are mechanically connected in series with being pivotally mounted with respect to each other for allowing orientation of the camera.

More specifically, the camera supporting part 30 comprises a first supporting member 32 hinged to the coupling part 20 pivotally about the yaw axis Y, a second supporting member 34 hinged to the first supporting member 32 pivotally about the roll axis R and a third supporting member 36 hinged to the second supporting member 34 pivotally about the pitch axis P, the third supporting member 34 holding the camera 12.

In the illustrated example, the first supporting member 32 is in the shape of a bent arm, the second supporting member 34 is in the shape of a yoke, and the third supporting member 36 is in the shape of a spherical housing in which the camera 12 is received, the third supporting member 36 being received between the two branches of the yoke shaped second supporting member 34.

Preferably, the support assembly 20 is configured for actively controlling orientation of the camera 12 and comprises electrical motors for controlling the rotation of the members. A yaw motor is provided between the support assembly coupling part 20 and the first supporting member 32, a roll motor is provided between the first supporting member 32 and the second supporting member 34, and a pitch motor is provided between the second supporting member 34 and the third supporting member 36. The motors are not visible in the perspective view and are located in the supporting members or in the joints connecting the supporting members. The locking ring 24 is arranged axially between the coupling part 20 and the camera supporting part 30. The camera supporting part 30 is connected to the coupling part 20 through the locking ring 24. More specifically, the first supporting member 32 is pivotally mounted on the coupling part 20 through the locking ring 24.

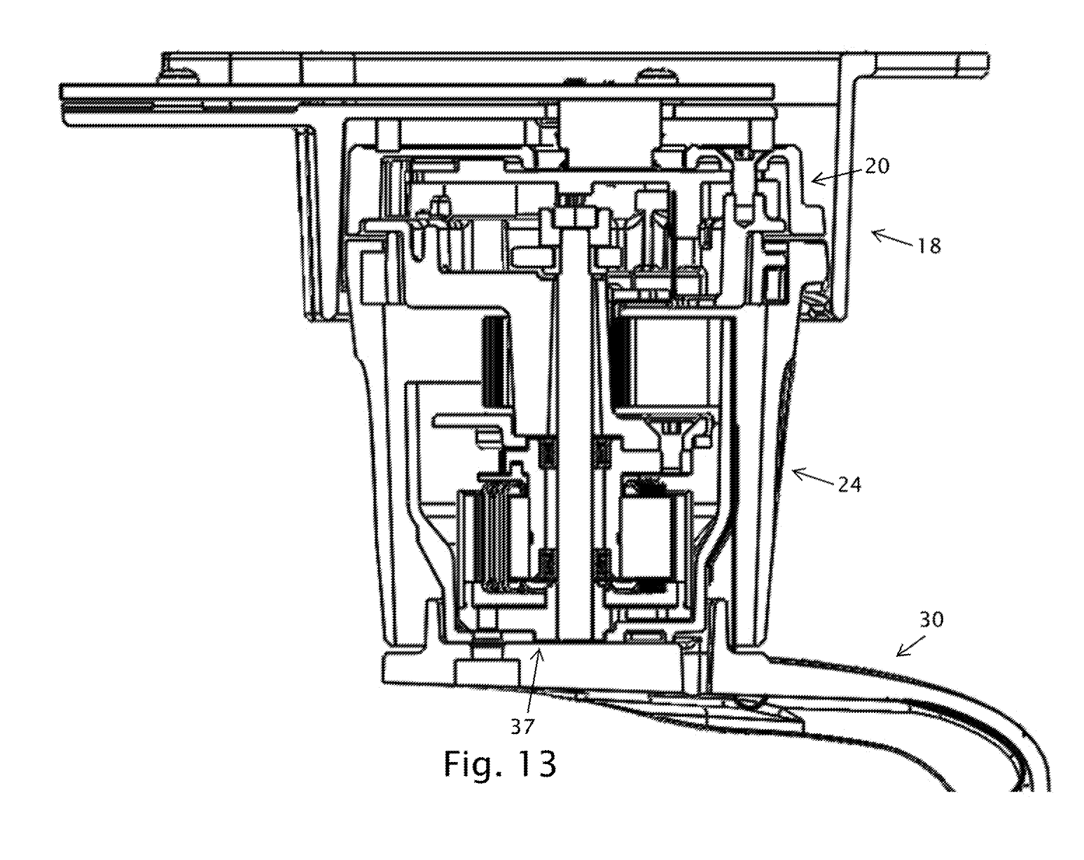

FIG. 13 shows a yaw motor 37 for controlling orientation of the first supporting member 32 relative to the coupling part 20 housed within the locking ring 24.

The locking ring 24 is provided with at least one locking pin 40. The locking ring 24 comprises preferably several locking pins 40 distributed on the circumference of the locking ring 24. In the example, the locking pins 40 protrude the external surface of the locking ring 24.

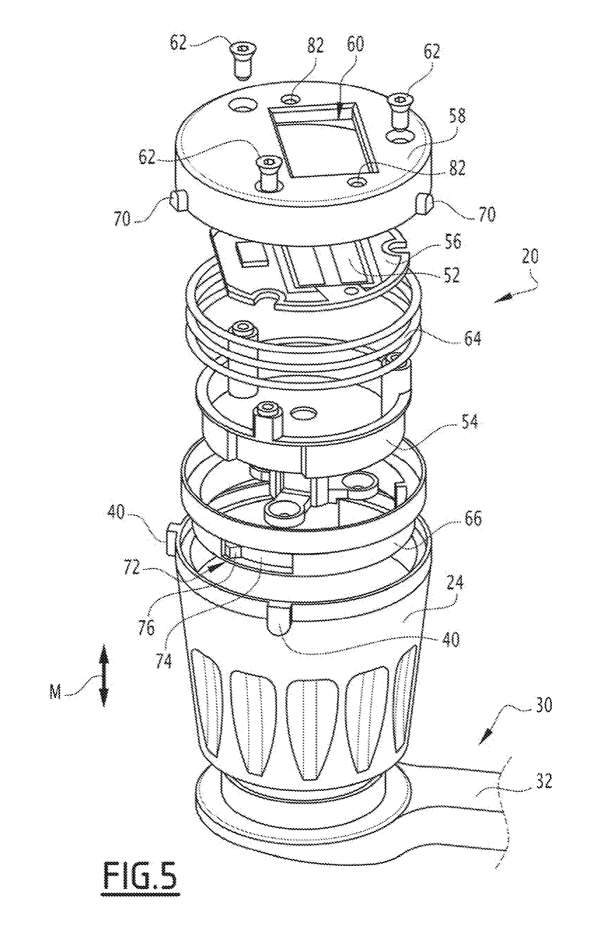

As illustrated on FIG. 4, for each locking pin 40, the base coupling part 18 comprises an axial groove 42 for insertion of said locking pin 40 axially along the coupling axis A upon coupling of the support assembly coupling part 20 to the base coupling part 18 and a substantially circumferential locking surface 44 extending circumferentially from the groove 42 to receive the locking pin 40 after of pivoting the locking ring 24 about the coupling axis A towards the locked position.

Upon coupling and locking the support assembly 16 to the base 14, each locking pin 40 is first inserted into the corresponding groove 42 upon engaging the support assembly coupling part 20 with the base coupling part 16, and moved along the corresponding locking surface 42 upon rotating the locking ring 24 in the locking direction (see arrows F1 and F2 on FIG. 4).

Once the locking ring 24 is pivoted, each locking pin 40 abuts against the locking surface 44 and axially locks the locking ring 24 relative to the base coupling part 18, thus preventing disengagement of the support assembly coupling part 20 from the base coupling part 18.

Optionally, as illustrated, each locking surface 44 is slightly inclined relative to a plane perpendicular to the coupling axis A such that pivoting the locking ring 24 into the locking direction urges the support assembly coupling part 20 into further engagement with the base coupling part 18. This allows smooth and progressive coupling and locking of the support assembly 16 to the base 14.

Optionally, at least one locking surface 44 and preferably each locking surface 44 comprises a step 46 to be passed by the locking pin 40 at the end of the rotation of the locking ring 24 in the locking direction. This step provides haptic feedback to the user, indicating that the locking ring is locked.

Each step 46 is oriented to oppose unlocking of the locking ring 24. Hence each step provides a security against unlocking. In view of unlocking the locking ring 24, the user has to force the locking ring 24 axially for each locking pin 40 to pass the corresponding step 46 before pivoting the locking ring 24 in the unlock direction.

The base 14 and the support assembly 16 are configured for electrical connection upon mechanical coupling. The base 14 and the support assembly 16 comprise respectively a base electrical connector 50 (FIG. 2) and a support assembly electrical connector 52 (FIG. 3) configured to mutually connect upon engaging the support assembly 16 with the base 14.

The base electrical connector 50 and the support assembly electrical connector 52 are configured for transmission of data signals and/or electrical power.

Electrical power transmission enables feeding motors controlling the spatial orientation of the camera 12 and/or the camera 12 carried by the support assembly 16 from an electrical source of the object to which the base 14 is attached.

Data signal transmission enables a communication between each motor and an object supporting the base. Such data signals may be control signals for controlling the orientation of the camera 12 based on inertial measures performed by an inertial unit of the object to which the base 14 is attached.

Data signal transmission enables communication between the camera 12 and an object to which the base 14 is attached. Such data signal may be control signal for controlling the camera 12 (e.g. for controlling a zoom of the camera) or a video signal send by the camera 12 to the object (e.g. to a recorder supported by the object or an emitter for emitting the video signal to a remote recorder or a remote display device).

The electrical connectors 50, 52 are configured for connecting axially along the coupling axis A.

In the illustrated embodiment, the base electrical connector 50 is provided at the bottom of the cavity of the base coupling part 18.

As visible on FIG. 5, in the illustrated embodiment, the support assembly coupling part 20 comprises a support piece 54, a printed circuit board 56 carrying the support assembly electrical connector 52 and a cover 58 covering the printed circuit board 56. The printed circuit board 56 is sandwiched between the support piece 54 and the cover 58.

The cover 58 comprises an aperture 60 through which the support assembly electrical connector 52 can connect to the base connector 50 upon coupling the support assembly 16 with the base 14. The cover 58 is attached to the support piece 54, e.g. by screws 62.

The support assembly 16 comprising a clamping system configured for clamping the support assembly coupling part 20 with the base coupling part 18 axially along the coupling axis A.

The clamping system is configured for elastically urging the support assembly coupling part 20 into engagement with the base coupling part 18 when the support assembly 16 is coupled to the base 14.

Such urging suppresses axial play between the support assembly and the base when they are coupled, which is beneficial for the stability of the camera.

In the illustrated embodiment, the locking ring 24 is mounted on the support assembly coupling part 20 with an axial play along the coupling axis A as illustrated by arrow M. The locking ring 24 can move axially along the coupling axis relative to the coupling part 20 with a limited stroke.

The clamping system comprises an elastic member 64 arranged between the locking ring 24 and the support assembly coupling part 20 for urging them away from each other.

Once the locking ring 24 is locked, the elastic member 64 urges the locking ring 24 axially against the locking surfaces and by reaction urges the support assembly coupling part 20 into further engagement with the base coupling part 18, towards the bottom of cavity the base coupling part 18.

In the illustrated example, the locking ring 24 is pivotally mounted on the coupling part 20 via a sliding ring 66.

More specifically, the sliding ring 66 is fixed in rotation relative to the support piece 54 and movable axially along the coupling axis A relative the support piece 54. The locking ring 24 is pivotally mounted on the sliding ring 66 about the coupling axis A and fixed axially relative to the sliding ring 66. Hence the locking ring 24 can move axially along coupling axis A relative to the coupling part 20 and pivot about the coupling axis A relative to the coupling part 20.

The elastic member 64 is arranged between the support assembly coupling part 20 and the sliding ring 66, thus pushing on the sliding ring 66.

The elastic member 64 is here provided as a helical spring. The elastic member 64 is arranged between the cover 58 and the sliding ring 66. The elastic member 64 surrounds the printed circuit board 56.

The base 14 and the support assembly 16 comprise an indexing system for indexing the orientation of the base 14 and the support assembly 16 about the coupling axis A upon coupling. The indexing system is configured to ensure that the electrical connectors 50, 52 are properly oriented one with respect to the other upon coupling the support assembly 16 to the base 14.

In the illustrated embodiment, the indexing system comprises indexing pins 70 provided on the support assembly coupling part 20, the indexing pins 70 being configured for insertion into axial grooves of the base coupling part 18. The indexing pins 70 are here provided on the cover 58.

The indexing pins 70 are unevenly distributed on the circumference of support assembly coupling part 20 such that the support assembly coupling part 20 can be inserted in the base coupling part 18 in one single angular position with respect to the coupling axis A.

In the illustrated example, the indexing pins 70 are provided for insertion into the axial grooves 42 configured for receiving the locking pins 40 of the locking ring 24.

In the unlocked position of the locking ring 24, each indexing pin 70 is aligned axially with a respective locking pin 40 and is thus ready for insertion into a groove 42.

In view of coupling the support assembly 16 to the base 14, it is necessary to rotate the locking ring 24 in the unlocked position such as to align the locking pins 40 with the indexing pins 70 along the direction of the coupling axis A, to axially engage the support assembly coupling part 20 with the base coupling part 18, and then to rotate the locking ring 24 for locking the support assembly 16 to the base 14.

Optionally, the indexing pins 70 and the corresponding grooves (here grooves 42) cooperate to prevent rotation of the support assembly coupling part 20 with respect to the base coupling part 18 about the coupling axis once the support assembly coupling part 20 is engaged with the base coupling part 18. This makes rotation of the locking ring 24 into the locking position easy. In a variant, the indexing pins 70 and the corresponding grooves are not configured for preventing rotation.

Optionally, the support assembly 16 and the locking ring 24 comprise a holding system for holding the locking ring 24 in the unlocked position when the support assembly 16 is disengaged from the base 14.

This avoids the locking ring 24 to pivot freely and maintains the locking ring 24 in the unlocked position, thus being ready for engaging the support assembly 16 with the base 14.

The holding system holds the locking ring 24 in the angular position in which the locking pins 40 are aligned with the indexing pins 70.

As illustrated on FIGS. 4 and 5, the holding system comprises a holding clip 72 arranged to engage a holding cavity 74 of the locking ring 24 when the locking ring 24 is pivoted in the unlocked position.

The clip 72 is provided on the sliding ring 66. The clip 72 comprises a cantilevered tab 76 extending circumferentially around the coupling axis A. The tab 76 is provided with a prong 78 configured for inserting into the cavity 74 of the locking ring 24.

Optionally, the base 14 and the coupling part 20 comprise a spacing system configured for maintaining a minimal spacing along the coupling axis A between the base electrical connector 50 and the support assembly electrical connector 52.

In the illustrated embodiment, the spacing system comprises spacers 80 (FIG. 2) in the shape of spacing pins provided on the base coupling part 18 and configured for contacting the printed circuit board 56 through holes 82 (FIG. 5) provided in the cover 58.

Such spacers 80 avoid an overstress of the electrical contacts of the electrical connectors 50, 52 upon coupling the support assembly 16 to the base 14.

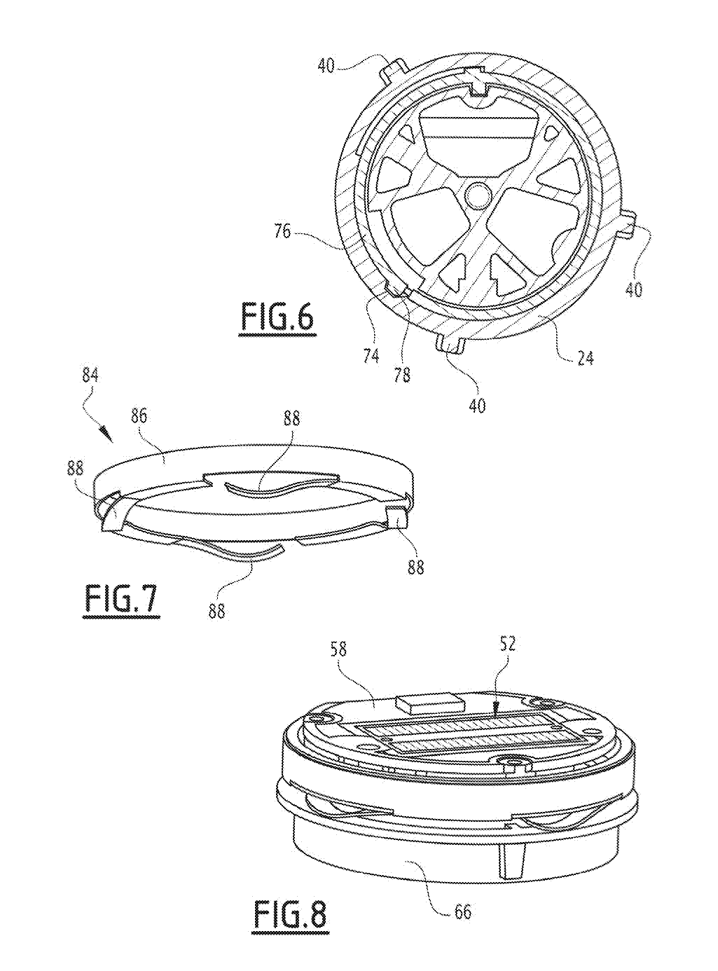

Each spacer 80 and the corresponding hole 82 prevent rotation of the support assembly coupling part 20 with respect to the base 14 about the coupling axis A once the support assembly coupling part 20 is engaged with the base coupling part 18. This makes rotation of the locking ring 24 into the locking position easy. The invention is not limited to the exemplary embodiment of FIG. 1-6. Modifications may be contemplated.

In an alternative embodiment illustrated on FIGS. 7 and 8, the elastic member 64 of the clamping system is provided as a spring ring 84 comprising an annular body 86 and spring tabs 88 extending circumferentially. Each tab 88 is axially elastically deformable. Several tabs 88 are distributed, preferably evenly, on the circumference of the body 86. The spring ring 84 is arranged to urge the locking ring 24 axially. The spring ring 84 is here attached to the printed circuit board 58 and arranged to urge the sliding ring 66 axially.

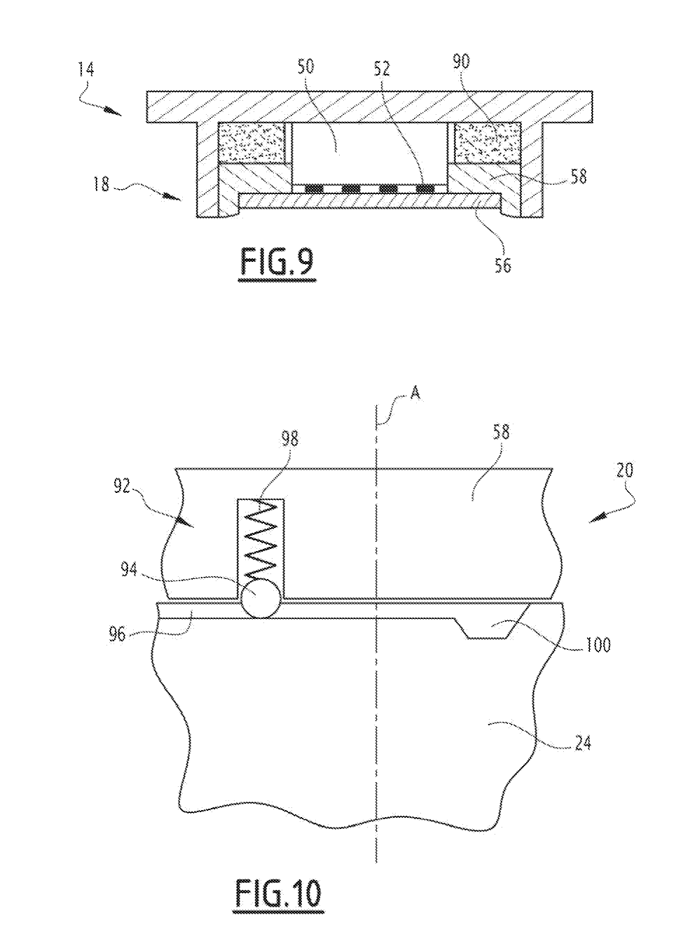

Alternatively or optionally, as illustrated on FIG. 9, the clamping system comprises an elastic member 90, e.g. a compressible pad, which is formed for example of a foam material, provided in the cavity of the base coupling part 18. The elastic member 90 is provided inside the cavity such as to be compressed by the support assembly coupling part 20 upon coupling the latter with the base coupling part 18.

The elastic member 90 is provided with an aperture for allowing connection of the electrical connectors 50, 52 through the elastic member 90. The elastic member 90 is for example annular for allowing connection of the electrical connectors 50, 52 through the pad 90.

In the embodiment illustrated on FIG. 10, a holding system for holding the locking ring 24 in at least one angular position comprises at least one holding assembly 92, each holding assembly 92 comprising a ball 94 mounted on the support assembly coupling part 20, e.g. the cover 58, and urged by a spring 96 axially with respect to the coupling axis A into a holding groove 98 formed on the locking ring 24, one holding cavity 100 being provided along the holding groove 98, each holding cavity 100 corresponding to one said angular position.

When the locking ring 24 reaches one said angular position, the ball 94 snaps into the corresponding cavity 100 under the action of the spring 96 and it is then necessary to apply to the locking ring 24 a moment that is sufficient to cause the ball 94 to exit the cavity 100 with overcoming the effort of the spring.

Each holding assembly 92 may comprises at least one holding cavity for holding the locking ring in the unlocked position and/or at least one holding cavity for holding the locking ring in the locked position.

The holding system prevents free rotation of the locking ring 24, thus making coupling and decoupling of the support assembly and the base easier. It also provides haptic feedback for the user which increases ease of use and security.

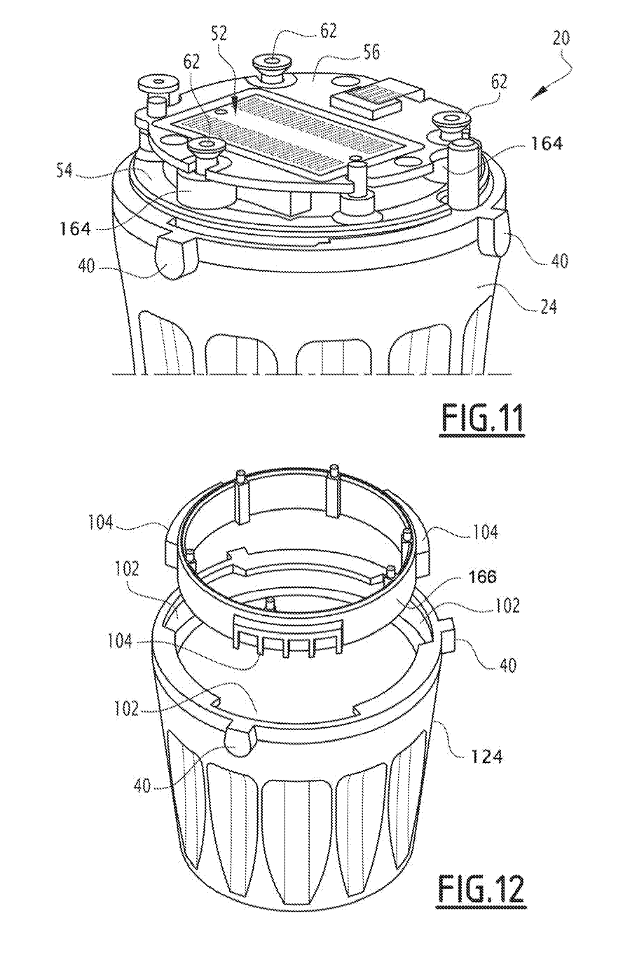

As illustrated in FIG. 11, in alternative or in addition to the elastic member 64 of FIG. 5 and/or the pad 90 of FIG. 9, the clamping system comprises one or several compressible elastic members 164 interposed between the support piece 54 and the support assembly connector 52, with being compressed axially upon coupling the support assembly coupling part 20 to the base coupling part 18.

In the illustrated example, each elastic member 164 is interposed between the support piece 54 and the printed circuit board 56 carrying the support assembly connector 52. Besides, each elastic member 164 is a tubular sleeve, which is formed for example of rubber, each elastic member 164 receiving a respective one of the screws 62 securing the cover 58 (not shown on FIG. 12 for sake of clarity) to the support piece 54. Only two such elastic members 164 out of three are visible on FIG. 11.

FIG. 12 illustrates an exploded perspective view of a locking ring 124 and a sliding ring 166 which are configured for being assembled into a unitary assembly according to an embodiment. The locking ring 124 and the sliding ring 166 are provided with corresponding notches 102 and protrusions 104 allowing axial insertion of the sliding ring 166 into an axial end of the locking ring 124 when the sliding ring 166 is in a predetermined orientation in which each notch 102 is aligned with the corresponding protrusion 104, and preventing disassembly once the sliding ring 166 has been pivoted with respect to the locking ring 124.

In this embodiment, after assembly, the locking ring 124 pivotally coupled to the sliding ring 166 and the sliding ring 166 is pivotally movable with respect to the support piece 54 (FIG. 5) to allow pivoting of the locking ring 124 with respect to the support piece 54 about the coupling axis A (FIG. 5).

In the illustrated example, the notches 102 are provided on the locking ring 124 and the protrusions 104 are provided on the sliding ring 166. In a variant, notches are provided on sliding ring 166 and the protrusions are provided on the locking ring 124.

1. A camera support system comprising:
a base configured to be fixedly attached to an object, the base comprising a base coupling part;
a support assembly configured for releasable coupling with the base, the support assembly comprising a support assembly coupling part configured for engaging with the base coupling part along a coupling axis and a camera supporting part for supporting a camera with allowing spatial orientation of the camera about at least one rotation axis; and
a locking ring pivotally mounted on the support assembly about the coupling axis for locking the support assembly with the base, the support assembly being configured for releasably coupling to the base by engaging the support assembly coupling part with the base coupling part along the coupling axis and subsequently pivoting the locking ring with respect to the base coupling part and the support assembly coupling part about the coupling axis for locking the support assembly to the base.

2. The camera support system as defined in claim 1, wherein the locking ring is provided with locking pins each configured for insertion into a corresponding groove of the base coupling part and for abutting a corresponding locking surface after rotation of the locking ring.

3. The camera support system as defined in claim 2, wherein at least one of the locking surfaces is provided with a step configured to cooperate with the locking pin to prevent unintentional unlocking of the locking ring.

4. The camera support system as defined in claim 2, wherein the support assembly coupling part comprises at least one indexing pin, each indexing pin configured to be aligned with a respective locking pin for engaging the support assembly coupling part with the base coupling part.

5. The camera support system as defined in claim 4, wherein each indexing pin is configured for preventing rotation of the support assembly coupling part with respect to the base coupling part about the coupling axis once the support assembly coupling part is engaged with respect to the base coupling part.

6. The camera support system as defined in claim 1, wherein the support assembly is configured for allowing rotation of the camera with respect to the base about at least two rotation axes distinct from each other.

7. The camera support system as defined in claim 6, wherein the at least two rotation axes are perpendicular to each other.

8. The camera support system as defined in claim 1, wherein the support assembly is configured for allowing rotation of the camera about three rotation axes, each rotation axis being perpendicular with each of the two other rotation axes.

9. The camera support system as defined in claim 1, wherein the base comprises a base electric connector and the support assembly comprises a support assembly electric connector configured for connecting upon coupling the support assembly coupling part to the base coupling part.

10. The camera support system as defined in claim 9, further comprising at least one spacer for maintaining a predetermined minimal spacing between the electrical connectors when the support assembly coupling part is coupled to the base coupling part.

11. The camera support system as defined in claim 10, wherein the at least one spacer is provided as at least one spacer pin disposed on the base coupling part and configured for contacting a piece of the support assembly coupling part supporting the support assembly electrical connector.

12. The camera support system as defined in claim 11, wherein said at least one spacer pin contacts the board through at least one corresponding aperture of a cover of the support assembly coupling part, said cover covering the piece supporting the support assembly electrical connector.

13. The camera support system as defined in claim 11, wherein each spacer pin and the corresponding aperture cooperate to prevent rotation of the support assembly coupling part with respect to the base coupling part about the coupling axis once the support assembly coupling part is engaged with respect to the base coupling part.

14. The camera support system as defined in claim 9, further comprising at least one compressible elastic member interposed between a support piece of the support assembly coupling part and the support assembly connector, the elastic member being compressed upon coupling the support assembly coupling part with the base coupling part.

15. A camera support system comprising:
a base configured to be fixedly attached to an object, the base comprising a base coupling part;
a support assembly configured for releasable coupling with the base, the support assembly comprising a support assembly coupling part configured for engaging with the base coupling part along a coupling axis and a camera supporting part for supporting a camera with allowing spatial orientation of the camera about at least one rotation axis; and
a locking ring pivotally mounted on the support assembly about the coupling axis for locking the support assembly with the base, the support assembly being configured for releasably coupling to the base by engaging the support assembly coupling part with the base coupling part along the coupling axis and subsequently pivoting the locking ring about the coupling axis for locking the support assembly to the base,
wherein the locking ring is axially movable along the coupling axis with respect to the support assembly coupling part, the camera support system comprising at least one elastic member configured for urging the locking ring and the support assembly coupling part away from each other.

16. The camera support system as defined in claim 1, further comprising a compressible elastic member arranged to be compressed between the support assembly coupling part and the base coupling part upon engaging the support assembly coupling part with the base coupling part.

17. The camera support system as defined in claim 1, wherein the camera supporting part is mounted on the support assembly coupling part.

18. A camera support system comprising:
a base configured to be fixedly attached to an object, the base comprising a base coupling part;
a support assembly configured for releasable coupling with the base, the support assembly comprising a support assembly coupling part configured for engaging with the base coupling part along a coupling axis and a camera supporting part for supporting a camera with allowing spatial orientation of the camera about at least one rotation axis; and
a locking ring pivotally mounted on the support assembly about the coupling axis for locking the support assembly with the base, the support assembly being configured for releasably coupling to the base by engaging the support assembly coupling part with the base coupling part along the coupling axis and subsequently pivoting the locking ring about the coupling axis for locking the support assembly to the base,
wherein the camera supporting part comprises a first supporting member part which is pivotally mounted on the support assembly coupling part about a first rotation axis.

19. The camera support system as defined in claim 18, wherein the first axis of rotation coincides with the coupling axis.

20. Camera support system as defined in claim 18, wherein the camera supporting part comprises a second supporting member hinged to the first supporting member part about a second rotation axis.

21. The camera support system as defined in claim 20, wherein the camera supporting part comprises a third supporting member hinged to the second supporting member part about a third rotation axis.

22. The camera support system as defined in claim 1, further comprising at least one motor for actively controlling orientation of the camera.

23. The camera support system as defined in claim 1, wherein the object is a vehicle or a handheld support.
